(19) United States
(12) Patent Application Publication
(10) Pub. No.: US 2009/0327868 A1
(43) Pub. Date: Dec. 31, 2009

(54) INTERMEDIATE APPARATUS AND METHOD

(75) Inventor: Takenori Tsukikawa, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/479,150

(22) Filed: Jun. 5, 2009

(30) Foreign Application Priority Data
Jun. 30, 2008 (JP) 2008-171234

(51) Int. Cl. G06F 17/00; G06F 15/16

(52) U.S. Cl. 715/239; 709/204

(57) ABSTRACT

An intermediate apparatus that intermediates between a client of a first type of service and a second type of service converts a service definition document of the second type of service into a service definition document of the first type of service according to a predetermined rule, and converts a message between a client of the first type of service and the second type of service according to the predetermined rule.

### BACKGROUND OF THE INVENTION

1. Field of the Invention

The present invention relates to an intermediate apparatus and a method that intermediates between a client of a first type of service and a second type of service.

2. Description of the Related Art

There are Web services in applications that users can utilize from the World Wide Web. In the following description, a connection procedure used when utilizing a Web service is referred to as a “protocol”. Conventionally, Web services have been generally supplied utilizing Simple Object Access Protocol (SOAP) as a protocol. However, in recent years Web services are also being provided in forms that do not utilize SOAP as a protocol.

Among these Web services that do not utilize SOAP, Web services that utilize REpresentational State Transfer (REST) are in widespread use. Although the term “REST” originally referred to an architectural style, gradually the term has also come to be utilized to refer to a system that performs remote calling by transmitting and receiving XML documents using HTTP.

In the following description, to differentiate between these two kinds of Web services, a Web service that has conventionally utilized SOAP is referred to as a “SOAP type service”. Further, a Web service that provides a service using the REST style without utilizing SOAP is referred to as a “REST type service”.

Web services are also utilized as technology that implements the linking or integration of applications. Sequentially executing a work flow that is a serial flow of operations or tasks is referred to as a “flow process”. It is possible to automate a flow process by utilizing a Web service.

Business Process Execution Language for Web Services (BPEL4WS) that is a flow process description language is available as a technology that automates flow processes. The specification of BPEL4WS is managed by the OASIS Web Service Business Process Execution Language TC of OASIS. The word “OASIS” stands for Organization for the Advancement of Structured Information Standards.

BPEL4WS uses WSDL (Web Services Description Language) as an interface that identifies a Web service. WSDL is a language used to write Web service interfaces, and its specification has been made public by the WWW consortium (W3C). The content can be viewed at http://www.w3.org/TR/wsdl.

However, the only Web services that can be linked with BPEL4WS are SOAP type services, and thus REST type services are not covered by BPEL4WS. There is therefore the problem that even though SOAP type services and REST type services are similarly utilized as stand-alone Web services, a single work flow that utilizes both a SOAP type service and a REST type service can not be implemented.

Regarding the above described problem that a system can not be utilized because of a difference in protocols, protocol conversion technologies are being utilized that make it possible to utilize a system by converting an unusable protocol into a different protocol that can be used. For example, refer to U.S. Patent Publication No. 2005/0125491.

According to U.S. Patent Publication No. 2005/0125491, a human performs conversion between a Web application to be utilized and a SOAP type service by manually inputting various parameters from a browser. As the conversion processing, first, a conversion rule is generated by analyzing the URL of the request with respect to the Web application that it is desired to convert. Thereafter, a dedicated protocol conversion unit corresponding to the Web application is generated. The protocol conversion unit appears to be operating as a server of a SOAP type service from the viewpoint of the client of the SOAP type service. Subsequently, the SOAP type service client application can receive the result of the Web application by accessing the dedicated protocol conversion unit in the same manner as when utilizing the SOAP type service.

However, according to the method described in U.S. Patent Publication No. 2005/0125491, as the number of supported Web applications increases, the number of protocol conversion units corresponding to the Web applications also increases. Therefore, in a case in which there is a limit to the memory usage amount, such as when a device that provides the protocol conversion units is an integrated device, it is not possible to accommodate a large number of Web applications. This is because as the number of Web applications that it is desired to support increases, the memory usage amount thereof also increases.

Further, protocol conversion units operating as servers for SOAP type services do not publicly disclose a WSDL document that is the interface definition of the SOAP type service. Consequently, since it is not possible to mechanically identify a service when linking a SOAP type service, the service can not be utilized with a flow process even though conversion processing has been performed. In addition, there is also the problem that the conventional method of generating a SOAP type service client can not be utilized. More specifically, a stub that serves as a prototype of the SOAP type service client cannot be generated by referring to the WSDL document. As a result, a large amount of time is consumed when developing a SOAP type service client.

### SUMMARY OF THE INVENTION

The present invention provides an apparatus that makes it possible for a client that utilizes a service of a certain type to also utilize a service of a type that is different to the aforementioned service.

According to one aspect of the present invention, there is provided an intermediate apparatus that intermediates between a client of a first type of service and a second type of service, comprising: a document conversion unit that converts a service definition document of a second type of service into a service definition document of a first type of service according to a predetermined rule; and a message conversion unit that converts a message between a client of the first type of service and the second type of service according to the predetermined rule.

Further features of the present invention will become apparent from the following description of exemplary embodiments with reference to the attached drawings.

### BRIEF DESCRIPTION OF THE DRAWINGS

FIG. 1 is a block diagram that illustrates an example of the configuration of a computer apparatus according to the embodiments;

FIGS. 2A to 2C are views that illustrates an example of a SOAP type service definition document that is described utilizing WSDL;

FIG. 3 is a view that illustrates general creation procedures for a SOAP type service server according to the embodiments;

FIG. 4 is a view that illustrates creation procedures for a SOAP type service client according to the embodiments;

FIG. 5 is a view that illustrates an example of a service definition document of a REST type service that is described utilizing WADL;

FIG. 6 is a view that illustrates conversion processing that is necessary to utilize a different Web service;

FIG. 7 is a view that illustrates the configuration of a system that performs transmission/reception message conversion processing without performing a service definition conversion;

FIGS. 8A and 8B are views for describing a conversion rule for service definition conversion processing;

FIGS. 9A and 9B are views that illustrate a request SOAP message that is transmitted according to the embodiments;

FIG. 10 is a view that illustrates the configuration of a system that performs transmission/reception message conversion processing according to the embodiments;

FIG. 11 is a view that illustrates a sequence of transmission/reception message conversion processing according to the embodiments;

FIG. 12 is a view for describing message conversion processing according to the embodiments; and

FIG. 13 is a view for describing message conversion processing according to the embodiments.

### DESCRIPTION OF THE EMBODIMENTS

Hereunder, best modes for carrying out the present invention are described in detail referring to the drawings.

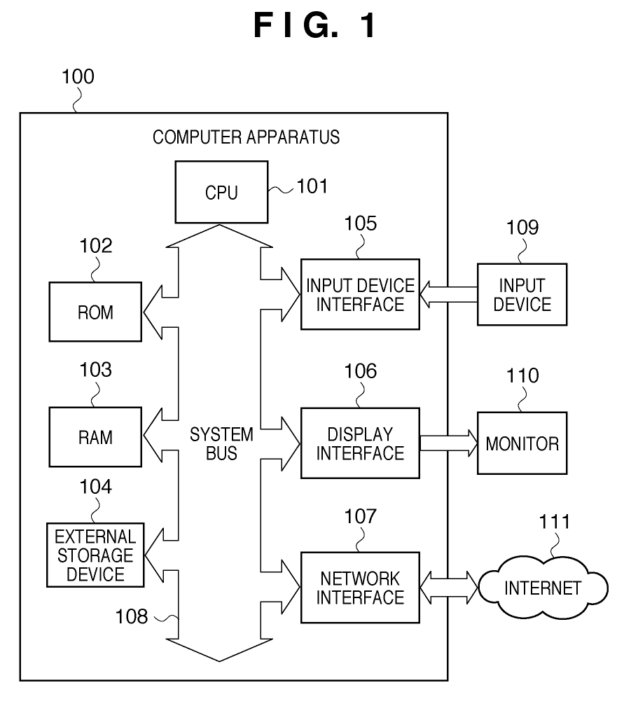

First, the configuration of a computer apparatus that functions as a server apparatus or a client apparatus is described referring to the block diagram shown in FIG. 1. The server apparatus or client apparatus may be implemented by a single computer apparatus, or as necessary a configuration may be adopted in which the server apparatus or the client apparatus is implemented by distributing the respective functions thereof among a plurality of computer apparatuses. In that case, it is sufficient to connect the computer apparatuses using a LAN (local area network) or the like to enable communication between each computer apparatus.

FIG. 1 is a block diagram that shows one example of the configuration of the computer apparatus according to the present embodiment. In FIG. 1, reference numeral 101 denotes a CPU that controls the entire computer apparatus 100. Reference numeral 102 denotes a ROM that stores programs or parameters that it is not necessary to change. Reference numeral 103 denotes a RAM that temporarily stores programs or data that are supplied from an external apparatus or the like.

Reference numeral 104 denotes a hard disk or a memory card that is fixedly installed in the computer apparatus 100, or an external storage device that is detachable from the computer apparatus 100. Examples of the external storage device include an optical disk such as a flexible disk (FD) or a compact disk (CD), a magnetic or optical card, an IC card, and a memory card. Reference numeral 105 denotes an input device interface with an input device 109 such as a pointing device or a keyboard that receives an operation performed by a user and inputs data.

Reference numeral 106 denotes a display interface with a monitor 110 for displaying data that is held by the computer apparatus 100 or supplied data. Reference numeral 107 denotes a network interface for connecting to a network circuit such as the Internet 111. Reference numeral 108 denotes a system bus that communicably connects each of the units 101 to 107.

It is to be understood that the object of the present invention may also be accomplished by supplying a system or an apparatus with a storage medium in which a program code of software which realizes the functions of the present embodiment is stored, and causing a computer (or CPU or MPU) of the system or apparatus to read out and execute the program code stored in the storage medium.

In this case, the program code itself read from the computer-readable storage medium realizes the functions of the aforementioned embodiment, and hence the storage medium in which the program code is stored constitutes the present invention.

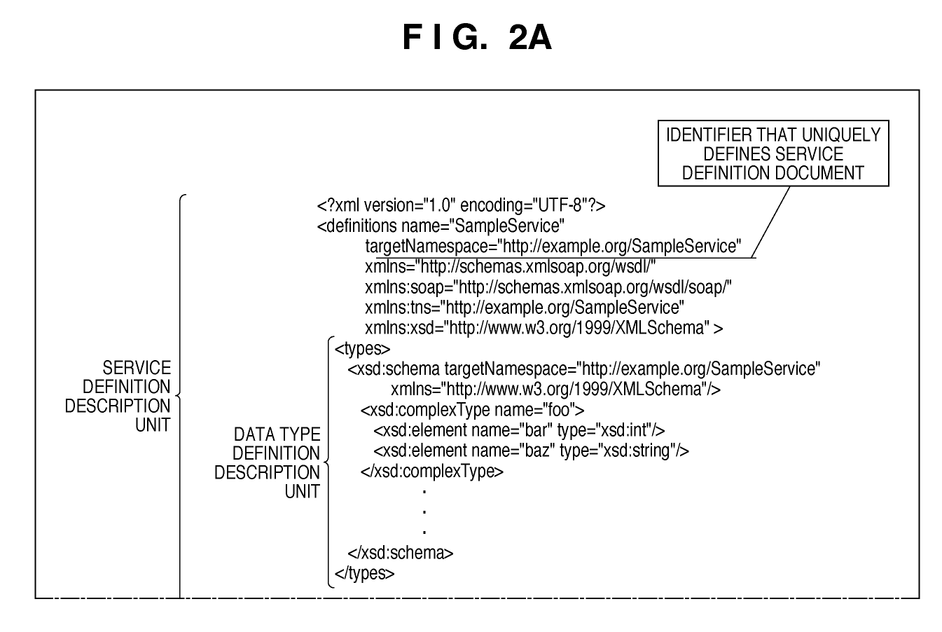

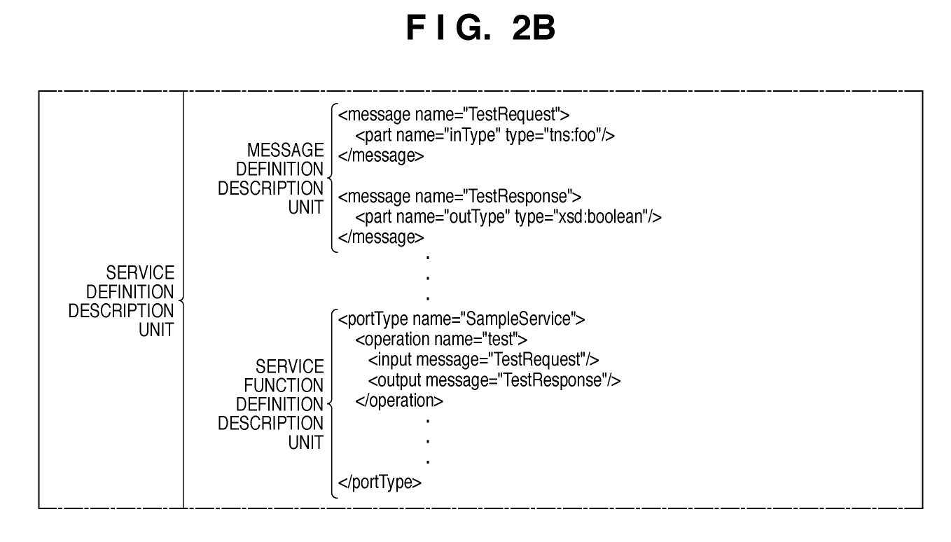

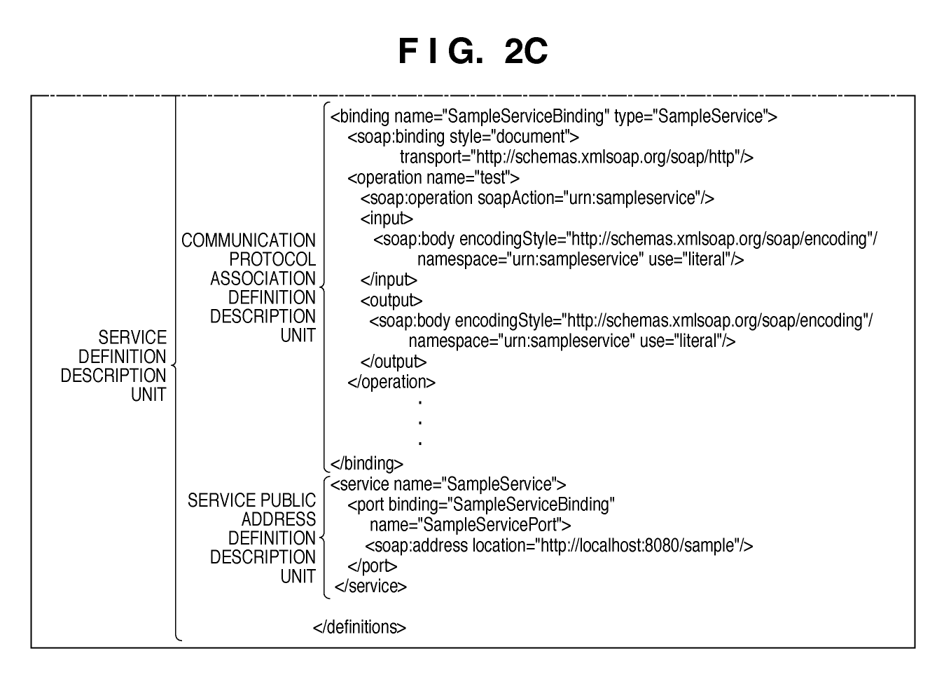

Next, a Web service that utilizes SOAP (hereunder, referred to as “SOAP type service”) is described. First, in a SOAP type service a service definition document exists that defines what kind of service the relevant service is. The service definition document utilizes WSDL (Web Services Description Language) as a description language. A SOAP type service definition document that is described utilizing WSDL will now be described referring to FIGS. 2A to 2C.

FIGS. 2A to 2C are views that illustrates an example of a SOAP type service definition document that is described utilizing WSDL. First, the service definition document is broadly divided into five sections. The overall service definition document starts with a <definitions> tag, and the service definition document itself can be uniquely identified with a targetNamespace attribute of the <definitions> tag.

The first of the five sections is a data type definition description unit. The data type definition description unit is started with a <types> tag, and describes data types that are described with XML Schema as a child element of the <types> tag. The XML Schema specification has been made public by the WWW consortium (W3C). The content can be viewed at http://www.w3.org/TR/xmlschema-0/, http://www.w3.org/TR/xmlschema-1/, and http://www.w3.org/TR/xmlschema-2/.

The second section is a message definition description unit. The message definition description unit is started with a <message> tag, and defines what kind of message to utilize for a data type defined by the data type definition description unit that is the first section. In the message definition description unit, a plurality of messages can be defined by arranging <message> tags side by side.

The third section is a service function definition description unit. The service function definition description unit is started by a <portType> tag, and defines a service function in combination with the message defined in the second section. Each service function is started with an <operation> tag. A message to be transmitted/received in order to utilize a service function is defined inside the <operation> tag. A plurality of service functions can be defined by arranging <operation> tags side by side.

The fourth section is a communication protocol association definition description unit. The communication protocol association definition description unit is started with a <binding> tag, and defines the association between the protocol that is actually used for communication and the service function defined in the third section. In the example shown in FIGS. 2A to 2C, SOAP is utilized as the protocol.

The fifth section is a service public address definition description unit. The service public address definition description unit is started with a <service> tag, and defines the association between the service that is defined in the first to fourth sections and the actual address that can be accessed. The address that is actually made public for users utilizing the service is defined by a <port> tag.

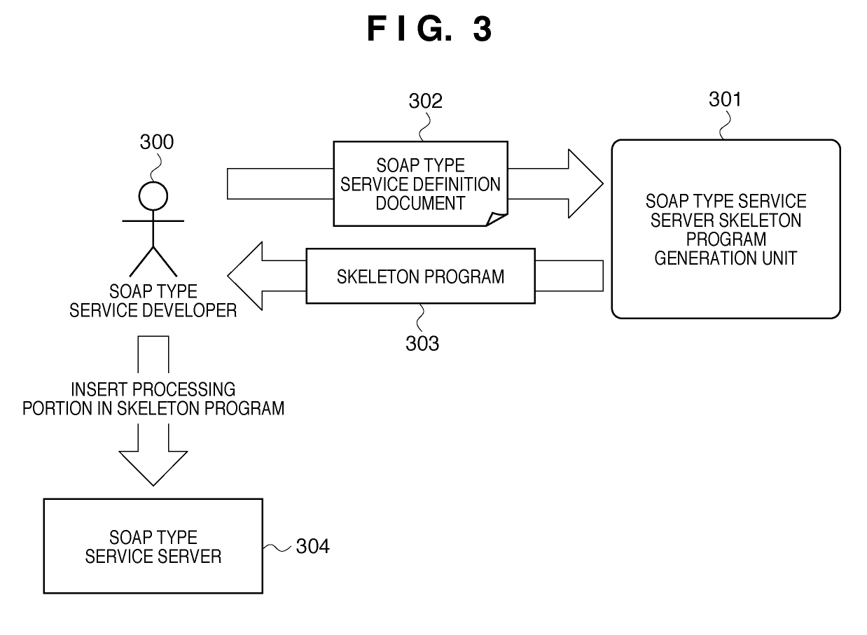

A service definition document of a SOAP type service is widely used when creating a server and a client of a SOAP type service. When creating a server application for a SOAP type service, the service definition document is created, and a skeleton program is created based on the service definition document. The skeleton program is a prototype of the server application of the SOAP type service. The creation procedures at that time will now be described referring to FIG. 3.

FIG. 3 is a view that illustrates general creation procedures for a SOAP type service server according to the present embodiment. A SOAP type service developer 300 transmits a SOAP type service definition document 302 as shown in FIGS. 2A to 2C to a SOAP type service server skeleton program generation unit 301. The SOAP type service server skeleton program generation unit 301 that receives the SOAP type service definition document 302 analyzes the SOAP type service definition document 302 to generate a skeleton program 303 and transmits the skeleton program 303 to the SOAP type service developer 300.

The SOAP type service developer 300 that receives the skeleton program 303 inserts a processing portion to be actually performed in the skeleton program 303 to thereby generate a SOAP type service server program 304.

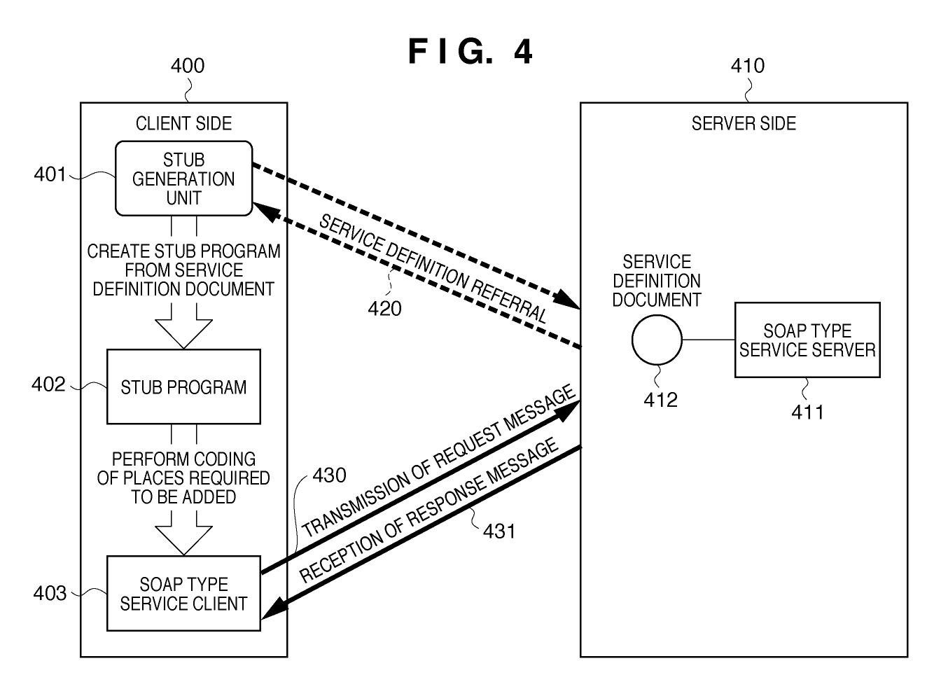

Further, similarly to when creating a server, when creating a client application of a SOAP type service a method is widely used that reads in a service definition document to generate a stub that serves as a prototype of a client application. The creation procedures at that time will now be described referring to FIG. 4.

FIG. 4 is a view that illustrates creation procedures for a SOAP type service client according to the present embodiment. A stub generation unit 401 exists on a client side 400. Further, a SOAP type service server 411 and a service definition document 412 of a SOAP type service are made public on a server side 410.

In this case, the stub generation unit 401 refers to the service definition document 412 that has been made public (420). The stub generation unit 401 generates a stub program 402 based on the service definition document 412. Next, the client application developer adds processing that is required as a client to the generated stub program 402 to complete a SOAP type service client 403.

In order to utilize the SOAP type service, the completed SOAP type service client 403 performs request message transmission of a SOAP message to the SOAP type service server 411 (430). The SOAP type service server 411 that receives the message executes the requested processing and sends the processing result in response as a SOAP message. The SOAP type service client 403 performs response message reception of the SOAP message (431).

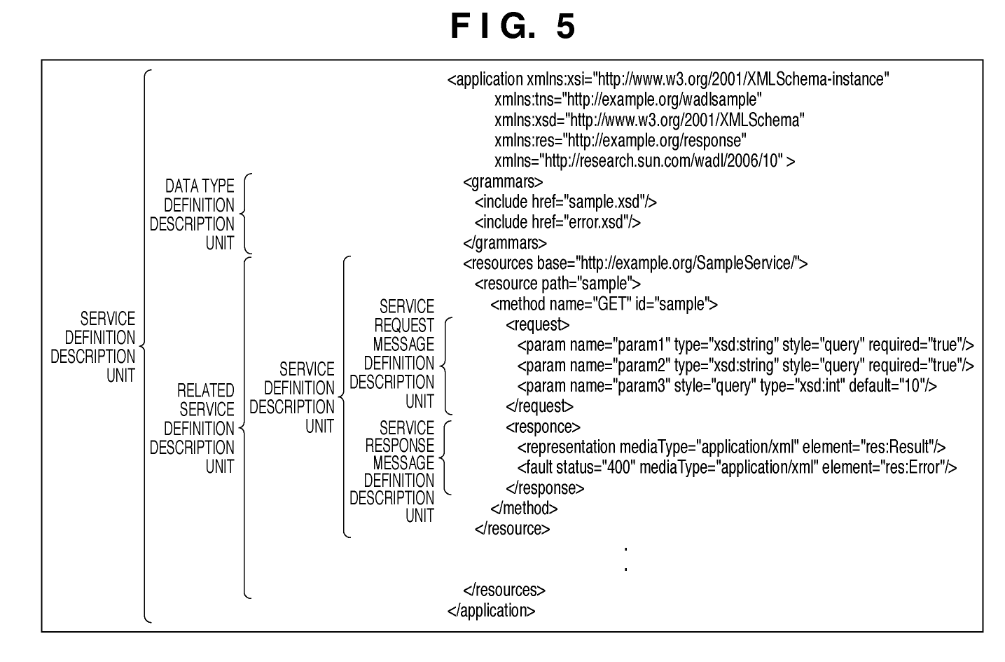

Next, a Web service that provides a service in a REST style without utilizing SOAP (hereunder, referred to as “REST type service”) is described. In a REST type service, similarly to the aforementioned service definition document that is described using WSDL, a service definition document is described utilizing WADL (Web Application Description Language). Similarly to WSDL, WADL is a language that is based on XML. The WADL specifications are made public at https://wadl.dev.java.net/. A service definition document of a REST type service that is described utilizing WADL will now be described referring to FIG. 5.

FIG. 5 is a view that illustrates an example of a service definition document of a REST type service that is described utilizing WADL. The REST type service definition document is broadly divided into two sections. The overall service definition document starts with an <application> tag.

The first of the two sections is a data type description unit. The data type description unit is started with a <grammars> tag, and describes a definition of the type of XML data that the REST type service handles. The data type definition is made with XML Schema, similarly to the aforementioned SOAP type service. As shown in FIG. 5, by using an <include> tag it is possible to read in an XML Schema file that is configured with a separate file or to directly describe a data type definition below the <grammars> tag.

The second section is a related service definition description unit.

The concept of a service differs between REST type services and SOAP type services. That is, a unit that is called a “service function” in a SOAP type service is handled as a service with the name resource in a REST type service. Further, a unit that is called a “service” in a SOAP type service is configured by a plurality of the “resource” as resources in the REST type service.

The related service definition description unit is started with a <resources> tag, and defines a plurality of services that are related. A URI that identifies a plurality of services that are related as an entirety is described with a base attribute of the <resources> tag. The URI is defined as the basic portion of the URL at which the plurality of services that are related are made public. The individual services are defined under a <resource> tag that is a child element of the <resources> tag.

The <resource> tag describes a URI that identifies individual services with a path attribute. By combining a value of the path attribute described here with a value of the base attribute of the <resources> tag, it is possible to construct an access destination address to be used when accessing individual services. Further, the <resource> tag has a <method> tag as a child element, and defines a method when accessing a service. There is also a <request> tag and a <response> tag provided in parallel with the <method> tag. The <request> tag defines a request message with respect to a service. The <response> tag defines a response message of a service. Further, since a plurality of <resource> tags can exist side by side as child elements of the <resources> tag, it is possible to define a plurality of services under the <resources> tag.

Next, a case of utilizing a REST type service as a second type of service from a SOAP type service client as a first type of service client is described. In this case, when the SOAP type service client attempts to utilize the REST type service, the SOAP type service client can not utilize the service because the protocols are different.

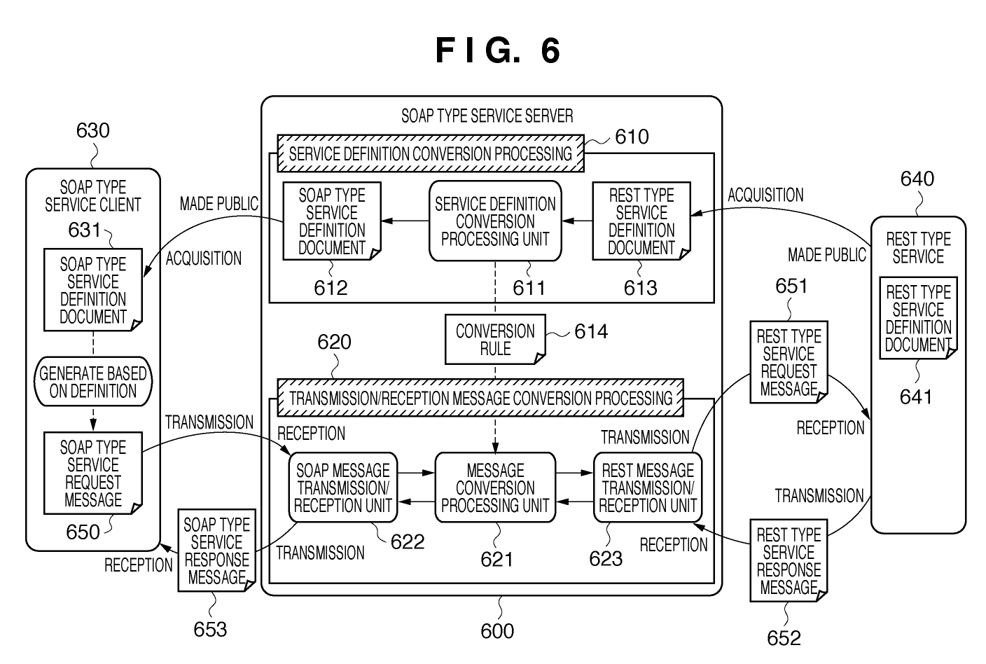

Therefore, a conversion must be performed in order for the SOAP type service client to utilize the REST type service. A configuration required for the conversion will now be described referring to FIG. 6.

FIG. 6 is a view that illustrates conversion processing that is necessary in order to utilize a different Web service. As shown in FIG. 6, two types of conversion processing are required. The first processing is a service definition conversion processing 610 that converts a service definition that is defined with a REST type service into a service definition of a SOAP type service. The second processing is a transmission/reception message conversion processing 620 that converts messages that are transmitted and received when actually utilizing the service. These two kinds of conversion processing are executed by a SOAP type service server 600.

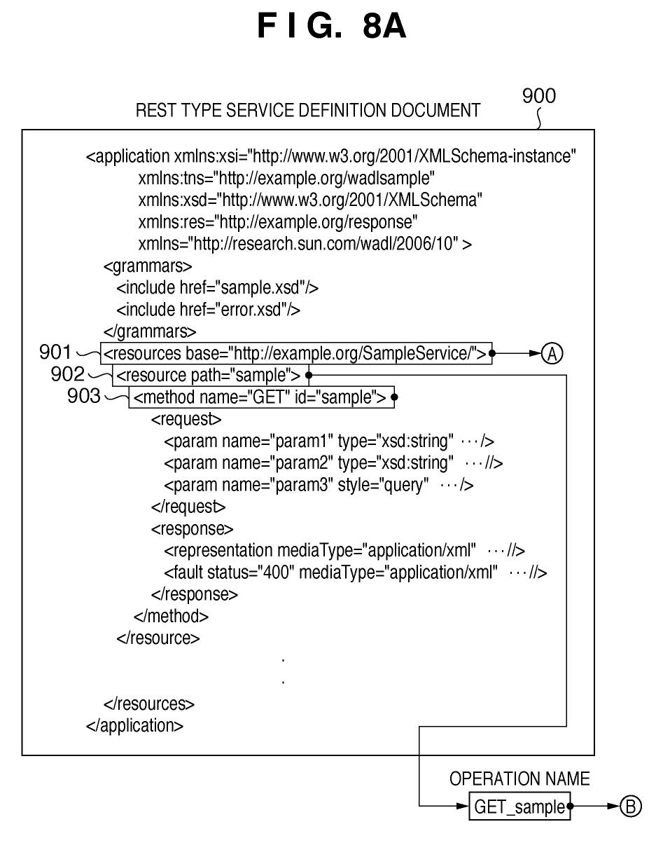

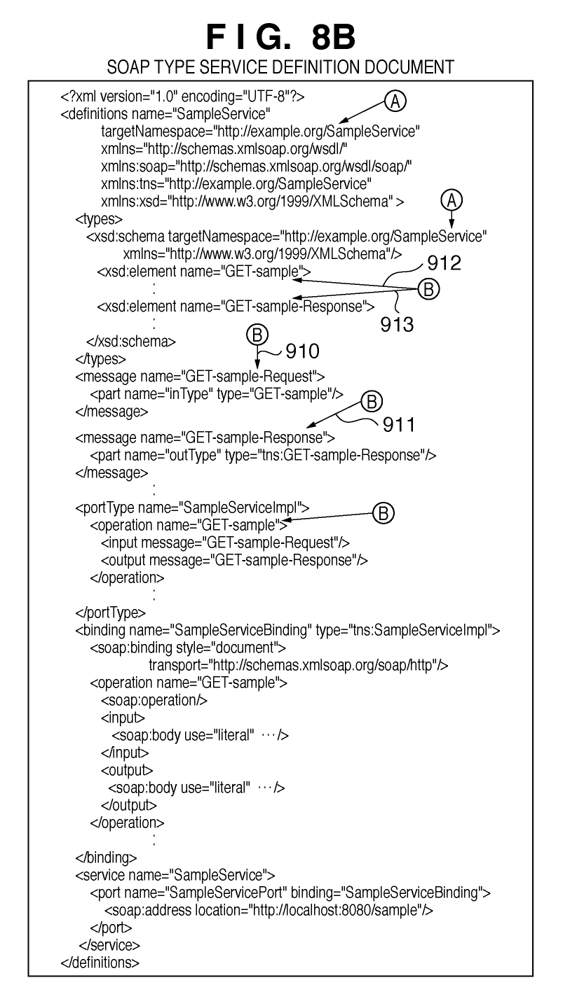

In the service definition conversion processing 610, a service definition conversion processing unit 611 acquires a REST type service definition document 641 in which a REST type service 640 is made public. In FIG. 6 the REST type service definition document 641 that is acquired is called a REST type service definition document 613. Next, the service definition conversion processing unit 611 performs conversion processing that extracts information that is required in order to define a SOAP type service from the acquired REST type service definition document 613, and generates a SOAP type service definition document 612. In this case, the service definition conversion processing unit 611 defines a conversion rule 614. The details of the conversion rule 614 are described later using FIGS. 8A and 8B.

Subsequently, by making public the SOAP type service definition document 612 that is generated by the conversion, the SOAP type service client 630 is able to recognize the REST type service 640.

The transmission/reception message conversion processing 620 includes a message conversion processing unit 621, a SOAP message transmission/reception unit 622, and a REST message transmission/reception unit 623. The following processing is performed. That is, the SOAP type service client 630 acquires the SOAP type service definition document 612 that the SOAP type service server 600 has made public. In FIG. 6, the SOAP type service definition document 612 that is acquired is called SOAP type service definition document 631. The SOAP type service client 630 generates a SOAP type service request message 650 based on a definition that is described in the acquired SOAP type service definition document 631. The SOAP type service client 630 then transmits the SOAP type service request message 650 that is generated to the SOAP message transmission/reception unit 622.

The SOAP message transmission/reception unit 622 that receives the SOAP type service request message 650 analyzes the SOAP type service request message 650, and transmits the analysis result to the message conversion processing unit 621. The message conversion processing unit 621 that accepts the analysis result generates a REST type service request message 651 using the conversion rule 614 that has been defined with the service definition conversion processing unit 611, and transmits the REST type service request message 651 to the REST message transmission/reception unit 623. Thus, by using the conversion rule 614 it is possible to generate a message that requests the REST type service 640 without referring to the REST type service definition document 641.

The REST message transmission/reception unit 623 that receives the REST type service request message 651 transmits the REST type service request message 651 to the REST type service 640. Subsequently, as a result, a REST type service response message 652 is received.

Next, the REST message transmission/reception unit 623 that receives the REST type service response message 652 analyzes the REST type service response message 652 and transmits the analysis result to the message conversion processing unit 621. The message conversion processing unit 621 that has accepted the analysis result converts the analysis result into a SOAP message that can be interpreted by the SOAP type service client 630, and transmits that converted message to the SOAP message transmission/reception unit 622 as a SOAP type service response message 653. Similarly to the conversion processing for the request message, this conversion processing is performed using the conversion rule 614 that is defined with the service definition conversion processing unit 611.

Next, the SOAP message transmission/reception unit 622 that has received the SOAP type service response message 653 transmits the SOAP type service response message 653 to the SOAP type service client 630. By means of this series of processing, the REST type service 640 can be utilized from the SOAP type service client 630.

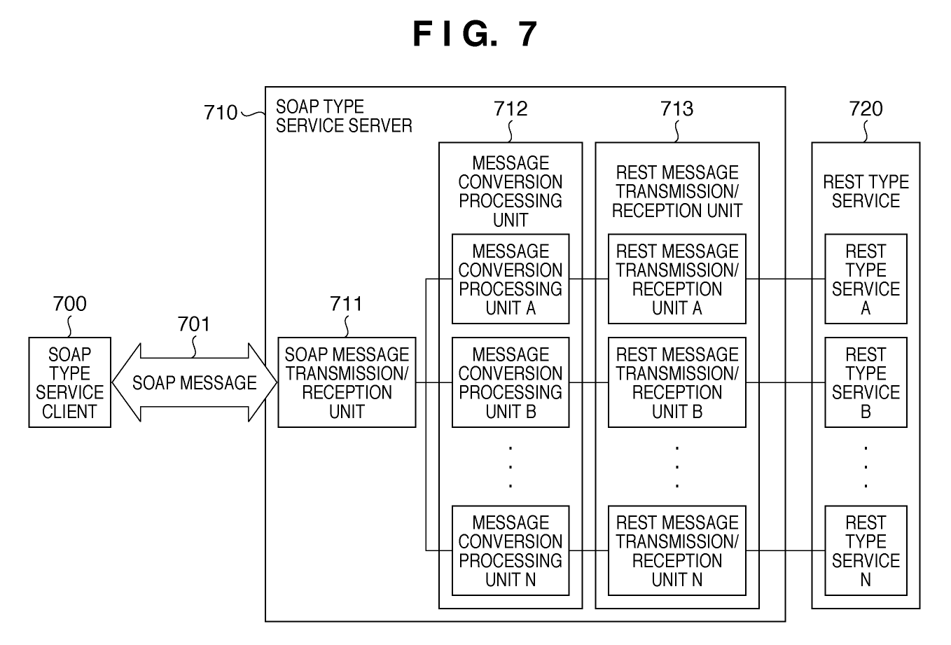

Next, transmission/reception message conversion processing that creates a service definition of a SOAP type service without performing a service definition conversion is described referring to FIG. 7.

FIG. 7 is a view that illustrates the configuration of a system that performs transmission/reception message conversion processing without performing a service definition conversion. When a SOAP type service client 700 attempts to utilize a REST type service 720, the service cannot be utilized because of a difference in protocols. Therefore, according to FIG. 7, the REST type service 720 is utilized by converting a SOAP message and a REST message by means of a message conversion processing unit 712. In this case, it is necessary to create a SOAP message transmission/reception unit 711, the message conversion processing unit 712, and a REST message transmission/reception unit 713 as a SOAP type service server 710.

In FIG. 7, the SOAP type service server 710 is created using a service definition document. By using this method, a SOAP type service definition document is used that is converted from a service definition document of an unsupported REST type service. Therefore, it is necessary to generate the same number of message conversion processing units 712 and REST message transmission/reception units 713 as the number of unsupported REST type services.

Consequently, a large amount of memory is used in order to support a plurality of REST type services, and utilization of this method in a device in which the memory usage amount is limited is difficult. Further, although originally it is sufficient to perform conversion processing for invoking a REST type service inside the SOAP message transmission/reception unit 711, in this case the redundant operations of deciding a SOAP type service to be invoked or allocating a value of an XML element in conformity with a type arise.

Among the processing performed by the SOAP message transmission/reception unit 711, the processing when a message from the SOAP type service client 700 is received will be described hereunder.

First, the SOAP message transmission/reception unit 711 receives a SOAP message 701 from the SOAP type service client 700. The SOAP message transmission/reception unit 711 analyzes the received SOAP message 701, and decides the corresponding service based on the analysis result.

Thereafter, the SOAP message transmission/reception unit 711 decides which service function to utilize in the decided service, and allocates a value of a corresponding XML element with respect to a type that the decided service function requests as an argument. By performing this processing, it is possible to distinguish among a plurality of existing message conversion processing units 712 when calling a specific message conversion processing unit 712.

Next, service definition conversion processing that converts from a service definition document of a REST type service to a service definition document of a SOAP type service using a conversion rule is described. In the service definition conversion processing, a conversion rule is established when converting from the service definition document of a REST type service to a service definition document of a SOAP type service. By establishing the conversion rule, the issue of transmission/reception message conversion processing is resolved. The service definition conversion processing in this case will be described referring to FIGS. 8A and 8B.

FIGS. 8A and 8B are views for describing a conversion rule in the service definition conversion processing. A related service identifier 901 as the value of a base attribute of a <resources> tag of a related service description unit inside a REST type service definition document 900 is utilized as the value of an attribute of a SOAP type service definition document. In this case, the identifier 901 is utilized as the value of a targetNamespace attribute of a <definitions> tag and the value of a targetNamespace attribute of a <schema> tag of XML Schema inside a <types> definition that are inside a SOAP type service definition document. More specifically, the basic portion of a URL at which a REST type service that is defined with the REST type service definition document is made public is described in the SOAP type service definition document.

Further, a URI 902 that identifies an individual REST type service and a method 903 for accessing the REST type service are joined with “_”, and utilized as a value of a name attribute of an <operation> element inside the SOAP type service definition document.

In the case of the REST type service definition document shown in FIGS. 8A and 8B, a path attribute value of a <resource> tag is “sample”, and a name attribute value of a <method> tag is “GET”. Accordingly, an <operation> tag that has the operation name “GET_sample” is generated inside the SOAP type service definition document.

The operation name is also used for a message definition name and a data type definition name. In this case, the term “message definition name” refers to a name attribute of a <message> element. For a request message name for an operation defined with the operation name, the operation name+“_Request” is used as denoted by reference numeral 910. In this case, the operation name is “GET_sample”. Further, for a response message name of an operation that is defined with the operation name, the operation name+“_Response” is used as denoted by reference numeral 911.

The term “data type definition name” refers to a name attribute value of an <element> element that is defined with XML Schema inside a <types> tag. A data type name of a request message for an operation that is defined with this operation name uses the operation name as it is, as in the case denoted by reference numeral 912. A data type name of a response message with respect to the request message uses operation name+“_Response”, as in the case denoted by reference numeral 913.

A SOAP type service definition document that is converted based on the conversion rule shown in FIGS. 8A and 8B, is made public as the SOAP type service definition document 612 by the SOAP type service server 600. According to the present embodiment, there is a single message conversion processing unit 621 even in a case in which the number of supported services increases. Therefore, the address of a SOAP type service that is defined inside the SOAP type service definition document 612 that is made public by the SOAP type service server 600 is always the same, regardless of a difference with a REST type service.

When actually performing conversion of a service definition document, it is possible to automate processing utilizing XSLT by focusing on the fact that WSDL and WADL are based on XML language. XSLT stands for XML Stylesheet Language Transformations.

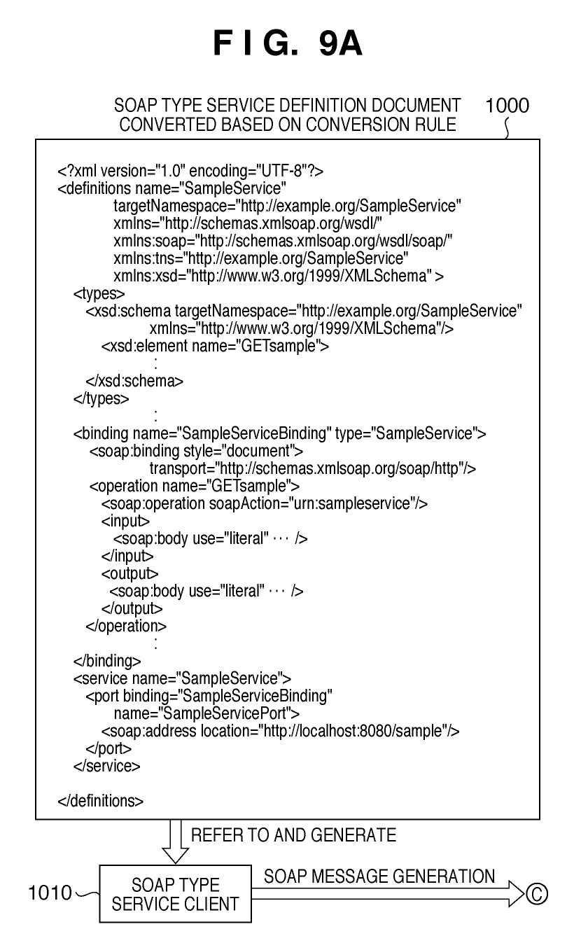

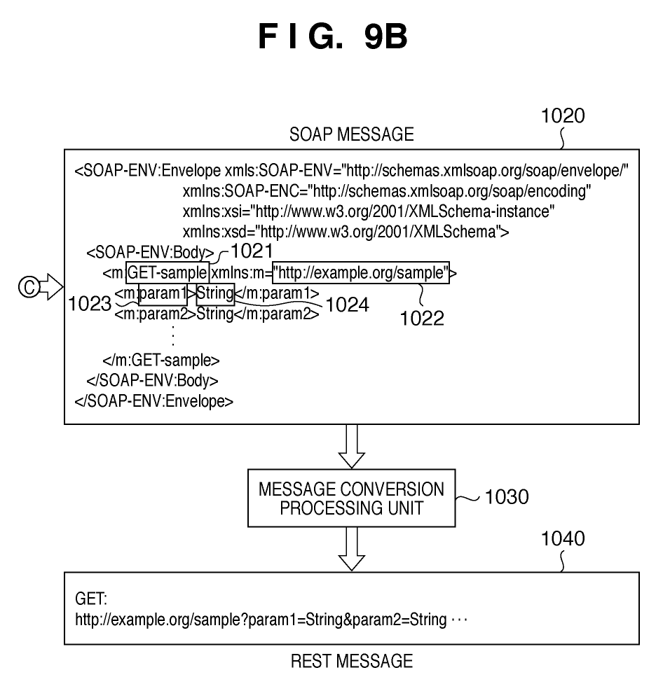

FIGS. 9A and 9B are views that illustrate a request SOAP message 1020 that is transmitted according to the present embodiment. When a SOAP type service client 1010 actually utilizes a service, the SOAP type service client 1010 refers to a SOAP type service definition document 1000 that has been created using the aforementioned conversion rule, and generates the SOAP message 1020.

As the result of the effect achieved by the aforementioned conversion rule, the SOAP message 1020 includes the address of a REST type service to be accessed and parameter information that is required when accessing in the SOAP message itself.

Since an initial child element name 1021 of a <Body> element is a value (GET_sample) in which a method “GET” used when accessing a REST type service and a path “sample” with respect to a basic address of the REST type service are joined by “_”, a message conversion processing unit 1030 (621) divides the value by character string processing. Further, a name space 1022 to which the initial child element of the <Body> element of the SOAP message belongs is the basic address of the REST type service to be accessed. In addition, a parameter that is required when accessing is described as a child element of a <GET_sample> element (1021). An element name 1023 is a parameter name, and a value 1024 is the value of a parameter.

The SOAP message 1020 (653) having this structure is subjected to conversion processing by a message conversion processing unit 1030 (621) to generate a REST message 1040 (652). The only item referred to during conversion processing is the SOAP message, and it is possible to create a REST message by character string processing only, without performing object allocation or the like.

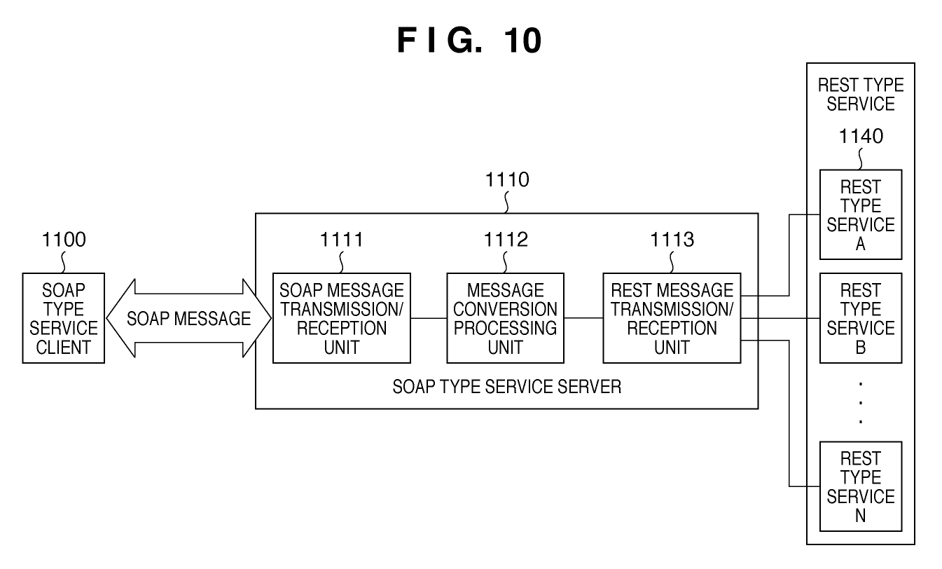

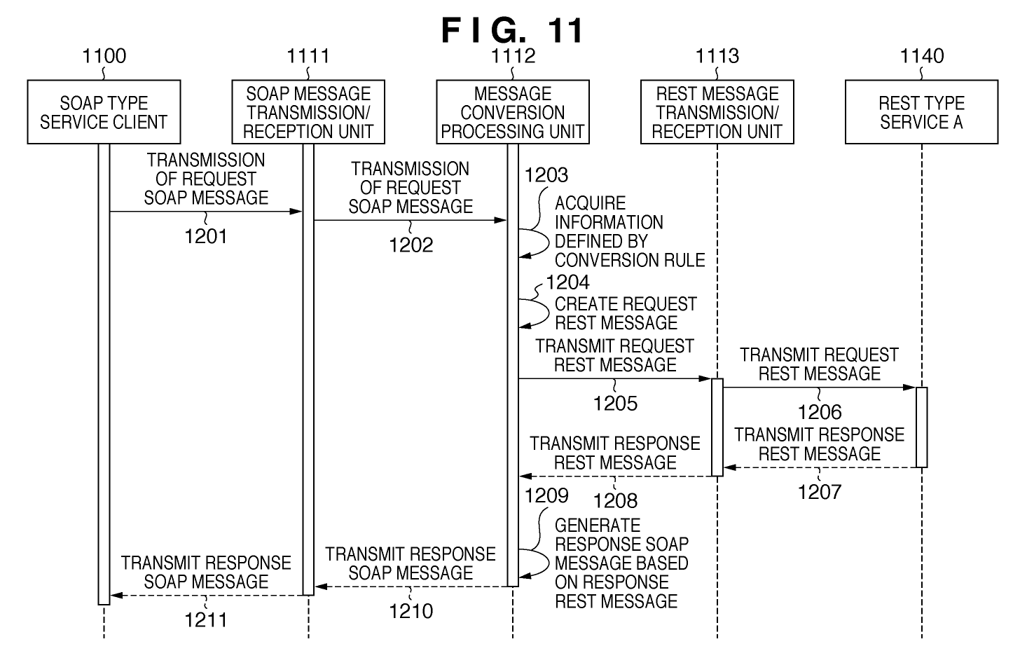

FIG. 10 is a view that illustrates the configuration of a system that performs transmission/reception message conversion processing according to the present embodiment. FIG. 11 is a view that illustrates a sequence of transmission/reception message conversion processing according to the present embodiment.

According to the present embodiment, conversion of a Web service is performed by accessing a SOAP type service server 1110 (600) from a SOAP type service client 1100 (630) to utilize a REST type service A 1140.

First, the SOAP type service client 1100 transmits a SOAP message to a SOAP message transmission/reception unit 1111 (1201). The SOAP message that is transmitted in this case is generated by referring to the SOAP type service definition document (612) that has been converted based on the aforementioned conversion rule.

The SOAP message transmission/reception unit 1111 transmits the received request SOAP message to a message conversion processing unit 1112 (1202). At that time, the analysis processing, deciding of a service and a service function, and processing to allocate a value of an XML element that have been performed in FIG. 7 are not performed.

The message conversion processing unit 1112 acquires information defined by the conversion rule from the received request SOAP message (1203). The message conversion processing unit 1112 generates a request message to be sent to the REST type service based on the acquired information (1204). Next, the thus-generated request REST message is transmitted to a REST message transmission/reception unit 1113 (1205).

The REST message transmission/reception unit 1113 that receives the request REST message transmits the request REST message to the REST type service A 1140 (1206). The REST type service A 1140 that receives the request REST message performs the requested processing, and transmits a response REST message as the result of that processing to the REST message transmission/reception unit 1113 (1207).

The REST message transmission/reception unit 1113 that receives the response REST message transmits the response REST message to the message conversion processing unit 1112 (1208). The message conversion processing unit 1112 that receives the response REST message generates a response SOAP message based on the response REST message (1209). The message conversion processing unit 1112 generates the response SOAP message by storing the response message from the REST type service A 1140 below the <body> element of the SOAP message. Subsequently, the message conversion processing unit 1112 transmits the generated response SOAP message to the SOAP message transmission/reception unit 1111 (1210).

The SOAP message transmission/reception unit 1111 that receives the response SOAP message transmits the received response SOAP message to the SOAP type service client 1100 (1211).

According to the present embodiment, it is not necessary to create a number of message conversion units that is equal to the number of supported REST type services as in the conventional technology, and it is adequate that there is always only one message conversion processing unit. This situation exists as a result of the conversion rule, and is because an address for accessing a REST type service and parameter information are included in the request SOAP message that is actually transmitted.

Next, a second embodiment according to the present invention is described in detail while referring to the drawings. As the second embodiment, an example of a case which is handled with file sharing is described.

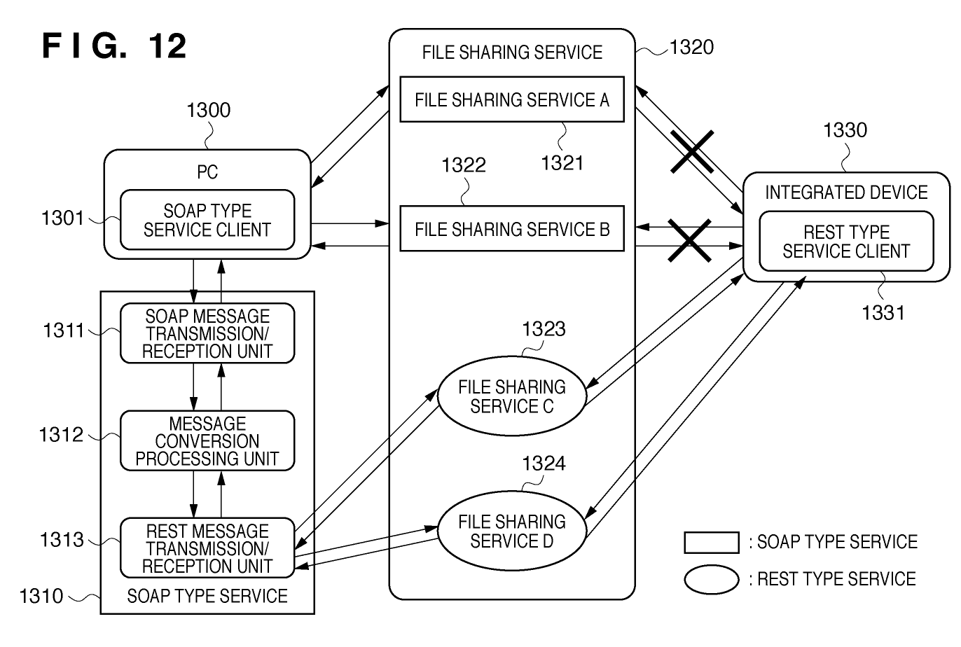

FIG. 12 is a view for describing message conversion processing according to the second embodiment.

According to this example, a SOAP type service client 1301 has resources to spare among the usable resources thereof. The SOAP type service client 1301 operates on a PC 1300 which is capable of utilizing a SOAP type service. The SOAP type service client 1301 is created on the assumption of utilization of a file sharing service that is provided with a SOAP type service. In this case, a file sharing service A 1321 and a file sharing service B 1322 are file sharing services provided as SOAP type services. However, since the SOAP type service client 1301 can only utilize a SOAP type service, the type service client 1301 can not directly utilize file sharing services C 1323 and D 1324 that are provided as REST type services.

Further, since there is a limit to the resources that can be used, an integrated device 1330 cannot utilize a SOAP type service. Accordingly, the integrated device 1330 utilizes a REST type service when utilizing a Web service. Therefore, the integrated device 1330 cannot utilize the file sharing service A 1321 or the file sharing service B 1322. Instead, a REST type service client 1331 can utilize the file sharing service C 1323 and the file sharing service D 1324 that are provided as REST type services.

When the Web services that can be utilized differ depending on the environment in which the client application operates as in this example, the problem arises that, depending on the type of devices, files cannot be shared. More specifically, the file sharing service C 1323 that the REST type service client 1331 can utilize cannot be utilized from the SOAP type service client 1301. Therefore, file sharing cannot be performed between the PC 1300 and the integrated device 1330.

To solve this problem, a method exists in which a REST type service client is also created in a device with abundant resources, and a created REST type service is utilized. However, since it is necessary to have two kinds of clients for accessing a file sharing service, additional development is required. Further, since the necessity also arises for the system to manage clients that communicate with different protocols, a new problem arises in that the system becomes complicated.

Therefore, by the SOAP type service client 1301 utilizing a conversion service of a Web service that publicly discloses the service definition document (612) as a SOAP type service 1310, the SOAP type service client 1301 can utilize a REST type service without additional development being performed. More specifically, the SOAP type service client 1301 transmits a request SOAP message to the SOAP message transmission/reception unit 1311 (622), and the message conversion processing unit 1312 (621) performs conversion from the request SOAP message to a request REST message.

Subsequently, a request REST message for accessing the file sharing service C 1323 is transmitted from the REST message transmission/reception unit 1313 (623). As a result, it is possible for the SOAP type service client to utilize the REST type service in the same way as a SOAP type service without developing a REST type client and without being aware of the REST type service.

The aforementioned message conversion processing unit 1312 is configured to be capable of supporting a plurality of REST type services with a single module. Therefore, even in a case of changing from the file sharing service C 1323 to the file sharing service D 1324, it is possible to utilize the file sharing service D 1324 by merely converting the REST type service definition document that is made public by the file sharing service D 1324 to a SOAP type service definition document and publicly disclosing the thus-converted document. At that time, no additional development work is required.

Next, a third embodiment according to the present invention is described in detail while referring to the drawings. As the third embodiment, an example of a case that is utilized with a flow process is described.

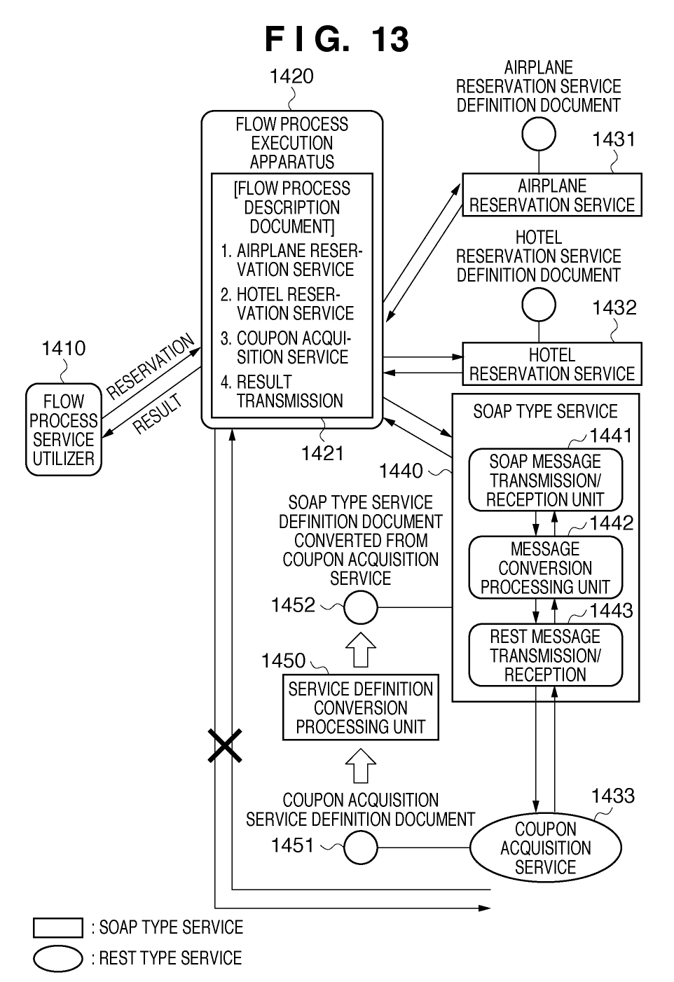

FIG. 13 is a view for describing message conversion processing according to the third embodiment. A flow process service utilizer 1410 shown in FIG. 13 is a utilizer of a work flow that links a plurality of SOAP type services. A flow process execution apparatus 1420 is an apparatus that establishes a single work flow by suitably calling SOAP type services. In this case, the example of a work flow that creates a travel plan is described.

Normally, a work flow to create a travel plan is one that first reserves an airplane ticket by utilizing an airplane reservation service 1431, and reserves a hotel utilizing a hotel reservation service 1432. In this case, a search is also performed regarding coupons that can be utilized at the travel destination, and if there is a request from the user to acquire the coupons, the necessity arises to execute a flow process as illustrated by a flow process description document 1421 as the work flow. More specifically, an airplane is reserved utilizing the airplane reservation service 1431, a hotel is reserved utilizing the hotel reservation service 1432, acquisition of coupons is performed with a coupon acquisition service 1433, and thereafter the result is transmitted.

However, in a case in which the coupon acquisition service 1433 is provided by a REST type service, the flow process execution apparatus 1420 that can only utilize a SOAP type service cannot perform the flow process. Hereunder, the message conversion processing of the third embodiment is described.

First, a service definition conversion processing unit 1450 (611) generates a SOAP type service definition document 1452 based on a coupon acquisition service definition document 1451 of the coupon acquisition service 1433. The conversion processing at the service definition conversion processing unit 1450 is performed according to the conversion rule that is described above using FIGS. 8A and 8B. After completing the conversion processing, the service definition conversion processing unit 1450 makes the SOAP type service definition document 1452 public.

As a result, by referring to the publicly disclosed SOAP type service definition document 1452, the flow process execution apparatus 1420 can recognize the coupon acquisition service definition document 1451 that is a REST type service, similarly to other SOAP type services. It is also possible for the flow process execution apparatus 1420 to utilize the coupon acquisition service 1433.

Subsequently, the flow process execution apparatus 1420 refers to the publicly disclosed SOAP type service definition document 1452 to generate a request SOAP message for service invocation. Thereafter, the flow process execution apparatus 1420 transmits the generated request SOAP message to a SOAP message transmission/reception unit 1441 (622). The SOAP message transmission/reception unit 1441 that received the request SOAP message transmits the request SOAP message to a message conversion processing unit 1442 (621).

The message conversion processing unit 1442 that received the request SOAP message extracts the address to be used when accessing a REST type service and parameters necessary for the request REST message from the request SOAP message in accordance with the aforementioned conversion rule. The message conversion processing unit 1442 generates a request REST message utilizing the extracted parameters.

Next, the message conversion processing unit 1442 transmits the extracted address and the generated request REST message to a REST message transmission/reception unit 1443 (623). The REST message transmission/reception unit 1443 utilizes the address and the request REST message transmitted by the message conversion processing unit 1442 to access a coupon acquisition service 1433, and receives a response REST message as a processing result.

The REST message transmission/reception unit 1443 that receives the response REST message transmits the response REST message to the message conversion processing unit 1442. After receiving the response REST message, the message conversion processing unit 1442 generates a response SOAP message based on the response REST message, and transmits the response SOAP message to the SOAP message transmission/reception unit 1441. The SOAP message transmission/reception unit 1441 that receives the response SOAP message transmits the response SOAP message to the flow process execution apparatus 1420.

As a result, the flow process execution apparatus 1420 can receive the processing result from the REST type service. Further, it is possible to incorporate a REST type service inside a flow process that is built with only SOAP type services.

Furthermore, by introducing the aforementioned conversion rule into the message conversion processing unit 1442, the REST type service that is a conversion target is not limited, and it becomes possible to handle a plurality of REST type services.

For example, in the case of adding a map guidance service that is provided by a REST type service, initially a REST type service definition document in which a map guidance service is defined is transmitted to the service definition conversion processing unit 1450. Next, the service definition conversion processing unit 1450 that accepts the service definition document performs conversion processing based on the aforementioned conversion rule, and makes a SOAP type service definition document public. Finally, a SOAP type service definition document that is the conversion processing result is made public as one service definition of the SOAP type service 1440.

Thus, although there is one processing portion in the SOAP type service 1440, two service definitions are made public, and it is possible to behave as though two services are operating in a pseudo-manner. Further, in the case of supporting a plurality of services, since the message conversion processing unit 621 at the time of execution is one entity, fewer computer resources are required.

According to the first to third embodiments, it is possible for a client of a SOAP type service to utilize a REST type service that does not utilize SOAP as a protocol. Further, as an effect at the time of execution, even when the number of supported REST type services increases, the required computer resources do not increase. This is because there is no change in the situation that conversion of Web services is performed by a single conversion processing unit, and hence the computer resources of the conversion processing unit are not affected by the number of supported services. Therefore, it is possible to operate the conversion processing unit even on an integrated device that has limited computer resources.

Further, since a conversion processing unit that performs Web service conversion makes a SOAP type service definition document public, it is possible to handle a REST type service in the same way as a SOAP type service within a flow process.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-171234, filed Jun. 30, 2008, which is hereby incorporated by reference herein in its entirety.

What is claimed is:

1. An intermediate apparatus that intermediates between a client of a first type of service and a second type of service, comprising:
a document conversion unit that converts a service definition document of a second type of service into a service definition document of a first type of service according to a predetermined rule; and
a message conversion unit that converts a message between a client of the first type of service and the second type of service according to the predetermined rule.

2. The apparatus according to claim 1, wherein the document conversion unit generates a name of an operation to be described in a service description document of the first type of service based on an identifier of a service that is described in a service definition document of the second type of service and a method for accessing the service.

3. The apparatus according to claim 1, wherein the document conversion unit generates a name of a message to be described in a service description document of the first type of service based on an identifier of a service that is described in a service definition document of the second type of service and a method for accessing the service.

4. The apparatus according to claim 1, wherein the message conversion unit receives a first message that is configured as a structured document from the client of the first type of service, and generates an address of the second type of service to be accessed based on a name space to which a predetermined element of the first message belongs.

5. The apparatus according to claim 1, wherein the document conversion unit generates a plurality of service definition documents of a first type which have a common service address and which respectively correspond to a plurality of services of a second type.

6. The apparatus according to claim 1, wherein the message conversion unit transmits a message to the second type of service via a network.

7. A conversion method that is executed by an intermediate apparatus that intermediates between a client of a first type of service and a second type of service, comprising:
first converting a service definition document of a second type of service into a service definition document of a first type of service according to a predetermined rule; and
second converting a message between the client of the first type of service and the second type of service according to the predetermined rule.

8. The method according to claim 7, wherein the first converting step generates a name of an operation to be described in a service description document of the first type of service based on an identifier of a service that is described in a service definition document of the second type of service and a method for accessing the service.

9. The method according to claim 7, wherein the first converting step generates a name of a message to be described in a service description document of the first type of service based on an identifier of a service that is described in a service definition document of the second type of service and a method for accessing the service.

10. The method according to claim 7, wherein the second converting step receives a first message that is configured as a structured document from the client of the first type of service, and generates an address of the second type of service to be accessed based on a name space to which a predetermined element of the first message belongs.

11. The method according to claim 7, wherein the first converting step generates a plurality of service definition documents of a first type which have a common service address and which respectively correspond to a plurality of services of a second type.

12. The method according to claim 7, wherein the second converting step transmits a message to the second type of service via a network.

13. The method according to claim 7, wherein the second converting step converts a message between the client of the first type of service and a file exchange service of the second type according to the predetermined rule.

14. The method according to claim 7, wherein the second converting step converts a message between the client of the first type of service that is processing a work flow and the second type of service according to the predetermined rule.

15. A storage medium that stores a computer program for causing a computer to execute a conversion method in an intermediate apparatus that intermediates between a client of a first type of service and a second type of service, the method comprising:
first converting a service definition document of a second type of service into a service definition document of a first type of service according to a predetermined rule; and
second converting a message between the client of the first type of service and the second type of service according to the predetermined rule.

16. The medium according to claim 15, wherein the first converting step generates a name of an operation to be described in a service description document of the first type of service based on an identifier of a service that is described in a service definition document of the second type of service and a method for accessing the service.

17. The medium according to claim 15, wherein the first converting step generates a name of a message to be described in a service description document of the first type of service based on an identifier of a service that is described in a service definition document of the second type of service and a method for accessing the service.

18. The medium according to claim 15, wherein the second converting step receives a first message that is configured as a structured document from the client of the first type of service, and generates an address of the second type of service to be accessed based on a name space to which a predetermined element of the first message belongs.

19. The medium according to claim 15, wherein the first converting step generates a plurality of service definition documents of a first type which have a common service address and which respectively correspond to a plurality of services of a second type.

20. The medium according to claim 15, wherein the second converting step transmits a message to the second type of service via a network.
